(19) United States
(12) Patent Application Publication
(10) Pub. No.: US 2006/0173755 A1
(43) Pub. Date: Aug. 3, 2006

(54) CATALOG MANAGEMENT APPARATUS, CATALOG GENERATION METHOD AND CATALOG RETRIEVAL METHOD

(75) Inventor: Makoto Mihara, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Ohta-ku (JP)

(21) Appl. No.: 11/275,843

(22) Filed: Jan. 31, 2006

(30) Foreign Application Priority Data
Feb. 1, 2005 (JP) 2005-025504

(51) Int. Cl. G06F 17/30

(52) U.S. Cl. 705/27

(57) ABSTRACT

The specification of the present application discloses a catalog management apparatus that is capable of managing a database in which merchandise related information that relates to merchandise is registered in a retrievable condition as a record, and catalog data which contains information relating to merchandise, comprising: a retrieval unit that retrieves catalog data one by one in predetermined constitutional units using predetermined merchandise related information; and an association unit that, when the merchandise related information is found in the catalog data by the retrieval unit, generates an association table in which the constitutional units are associated with a record of the database that includes the merchandise related information.

### FIELD OF THE INVENTION

The present invention relates to a catalog management apparatus that manages an electronic catalog that, for example, is accessible from a network or the like, a catalog generation method and a catalog retrieval method. More specifically, the invention relates to a catalog management apparatus, catalog generation method and catalog retrieval method that can generate a user-friendly electronic catalog by associating a merchandise master database and an electronic catalog, and can retrieve a corresponding electronic catalog based on a keyword.

### BACKGROUND OF THE INVENTION

Electronic catalog systems that construct an electronic catalog in a server in a computer network and provide the electronic catalog to users over a network are already known. For manufacturing companies whose merchandise extends over a variety of areas, the electronic catalogs can be very large. Therefore, retrieval means that are easy to use and that can effectively select the exact catalog desired by the user are required.

An electronic catalog system that can perform retrieval using lexical information has already been proposed as a means of retrieving an electronic catalog (refer to Japanese Patent Laid-Open No. 2000-123034 (paragraph 0063-0081)). In that document, an electronic catalog system Is described whereby when the configuration of a database of a catalog user and the configuration of the electronic catalog system of the vendor that the catalog user is attempting to utilize are different, the system performs data mapping of terms of the user system and terms of the electronic catalog that were associated with lexical information of ISO 13584. According to that system, an input retrieval word is first retrieved based on class names of the electronic catalog, and if the retrieval word is a catalog class, the catalog contents are identified from the matching class name. As used herein, the term “catalog contents” refers to digital data included in an electronic catalog, including data such as text, still images and graphics. The catalog contents may also include dynamic images, speech, or the like. If a retrieval word is a synonymous word or an abbreviation of a catalog class, a retrieval operation Is conducted with respect to the tree structure of classes in lexical information attached to the electronic catalog to obtain a class name that corresponds with the abbreviation or synonymous word that matches the retrieval word. When the retrieval word is a word relating to a catalog attribute, the class name is also determined by searching the tree structure of the class in the lexical information. The electronic catalog is generated from catalog contents including all the subclasses of the required class. Thus, by providing the lexical information of ISO 13584 in the electronic catalog itself, there is greater flexibility with respect to retrievable keywords.

However, in order to produce an electronic catalog as described in the aforementioned document, lexical information must also be generated at the same time. It is necessary to register words indicating synonymous words or abbreviations of class names, for example, product categories, as well as attributes thereof and the like in the lexical information. Generating the lexical information thus requires an enormous amount of labor. Nevertheless, without providing means for efficiently conducting a catalog retrieval operation it would be difficult for a user to select the appropriate catalog and the reason for the existence of the electronic catalog would be lost.

### SUMMARY OF THE INVENTION

The present invention was made in view of the above-described conventional examples, and an object of this invention is to provide a catalog management apparatus, catalog generation method and catalog retrieval method that can efficiently generate an electronic catalog with a small amount of labor and high productivity, that allows a user to carry out efficient retrieval operations.

In order to achieve the above object, this invention has the following configuration:

A catalog management apparatus that is capable of managing a database in which merchandise related information that relates to merchandise was registered in a retrievable condition as records, and catalog data which contains information relating to merchandise, comprising:

retrieval means that-retrieves catalog data one by one in predetermined constitutional units using predetermined merchandise related information; and

association means that, when the merchandise related information was found in the catalog data by the retrieval means, generates an association table in which the constitutional unit is associated with a record of the database that includes the merchandise related information.

Alternatively, there is provided a catalog generation method that associates a database in which a merchandise name and data relating to the merchandise name were associated and registered in a condition in which either thereof can be retrieved, and catalog data which contains information relating to merchandise, comprising:

a retrieval step that retrieves catalog data one by one in predetermined constitutional units using a merchandise name; and

an association step that generates an association table that, when the merchandise related information was found in the catalog data by the retrieval step, associates the relevant constitutional unit with a record of the database that includes the merchandise related information.

Alternatively, there is provided a catalog retrieval method for performing a retrieval operation with respect to generated catalog data comprising:

a second retrieval step that performs a retrieval operation with respect to the database using a keyword;

a catalog identification step that, when a record relating to the keyword was identified by the second retrieval step, refers to the association table to identify a constitutional unit of catalog data that corresponds to the record; and

an output step that outputs the constitutional unit of catalog data that was identified by the catalog identification step as a catalog retrieval result.

Alternatively, there is provided an electronic catalog that is accessible by a computer, including:

a catalog contents table including a file name corresponding to a contents ID;

a merchandise master database table in which are associated a data ID, a category to which the data belongs, and a data item included in the data; and

a data/contents management table in which a data ID and a contents ID are associated; wherein

the electronic catalog is constituted such that, when a value of the data item is assigned, a computer can perform an operation to acquire a data ID by searching the merchandise master database table, search the data/contents management table using the acquired data ID to acquire a contents ID that was associated therewith, and identify a file name corresponding to the acquired contents ID.

According to this invention, it is possible to simply and efficiently generate an electronic catalog for which a retrieval operation using a keyword can be performed efficiently and exactly. According to the generated electronic catalog, a page of the catalog that relates to the keyword can be reconfigured and provided to the user, and thus the utilization ratio of resources when transferring data and printing can be enhanced. Further, since a user can select a merchandise name and a catalog page to be associated from candidate merchandise names, exact association can be realized.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a system configuration diagram illustrating an outline configuration of an embodiment of this invention;

FIG. 2 is a block diagram illustrating the device configuration of an embodiment of this invention;

FIG. 3 is a block diagram illustrating the module configuration of an embodiment of this invention;

FIG. 4 is a view illustrating one example of a database table of this invention;

FIG. 5 is a view illustrating one example of a flowchart showing a process for registration of catalog data according to this invention;

FIG. 6 is a view illustrating one example of a function-listing screen of this invention;

FIG. 7 is a view illustrating one example of a merchandise master database registration function screen of this invention;

FIG. 8 is a view illustrating one example of a screen for confirming a data file to be registered in a server according to this invention;

FIG. 9 is a view illustrating one example of a screen for selecting catalog data to be registered according to this invention;

FIGS. 10A and 10B are views illustrating one example of the contents of a database in which merchandise master data and catalog data were registered according to this invention;

FIG. 11 is a view illustrating one example of a screen for confirming catalog data with which a merchandise master database is not associated according to this invention;

FIG. 12 is a view illustrating one example of a flowchart that shows the details of a process that extracts characters from a catalog according to this invention;

FIG. 13 is a view illustrating one example of a flowchart that shows the details of a process that determines a category of a catalog according to this invention;

FIG. 14 is a view illustrating one example of a screen for verifying and deciding a category of a catalog according to this invention;

FIG. 15 is a view illustrating one example of a flowchart that shows the details of an association and decision process according to this invention;

FIG. 16 is a view illustrating one example of a flowchart that shows the details of a process to generate a list of candidates to be associated that is performed when generating an association and confirmation screen according to this invention;

FIG. 17 is a view illustrating one example of a screen for verifying and deciding an association according to this invention;

FIG. 18 is a view illustrating one example of the contents of a database in a case where association of a catalog and a merchandise master database was performed, in relation to the database shown in FIGS. 10A and 10B according to this invention;

FIG. 19 is a view illustrating one example of a flowchart that shows the details of a catalog output process according to this invention;

FIG. 20 is a view illustrating one example of a merchandise retrieval result screen according to this invention;

FIG. 21 is a view illustrating one example of a flowchart that shows the details of a process for combining catalogs according to this invention;

FIG. 22 is a view illustrating one example of a screen for verifying and deciding an association according to this invention;

FIG. 23 is a view illustrating one example of a screen for registering a merchandise master database when performing association according to this invention;

FIG. 24 is a view illustrating one example of a screen for verifying and deciding an association according to this invention;

FIG. 25 is a view illustrating one example of a merchandise retrieval result screen according to this invention; and

FIG. 26 is a view showing one example of a flowchart of a merchandise retrieval operation according to this invention.

### DETAILED DESCRIPTION OF THE PREFERRED EMBODIMENTS

### OVERVIEW OF THE INVENTION

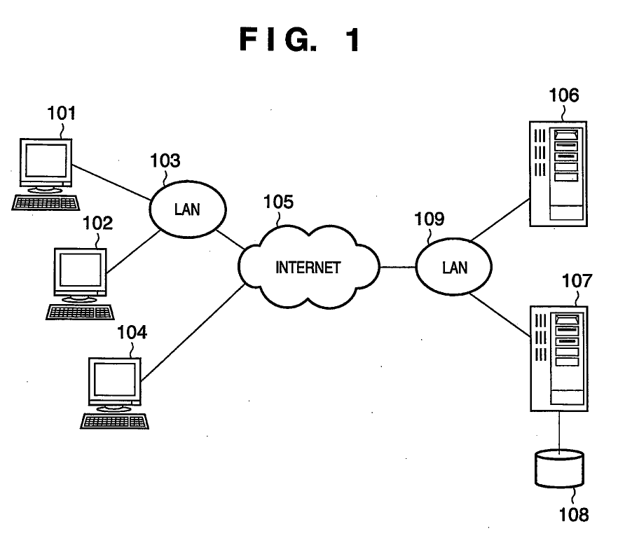

A catalog server that is the catalog management apparatus of this invention extracts text information of each page of an electronic catalog when registering the electronic catalog. A page is a constitutional unit of the electronic catalog. The catalog server determines whether or not information included in an arbitrary column of a merchandise master database is included in the extracted text information. If the information in question is included, the catalog server associates the electronic catalog with the merchandise master database. When extracting text, the catalog server determines the character size that is most utilized in the text information included in the electronic catalog. The character size of beneficial information such as product names that is included in the catalog is larger than the ordinary descriptive text. The catalog server provides support for the association process by utilizing this fact to display to a user a keyword determined from among characters of a larger size than the character size that was acquired by determining the most utilized size. Further, there are many cases in which a single electronic catalog introduces a specific product series. There are also many cases in which the first page of a catalog includes a key that shows the product series of the catalog. Therefore, before searching each page of the catalog with all the keywords of the merchandise master database, the category to which the catalog belongs is determined by information such as the product category registered in the merchandise master database or the series. The catalog server utilizes only product master data of categories to which the keywords for searching the text of each page belong, as candidates for a merchandise master database with which the electronic catalog is to be associated. As a result, association of an electronic catalog with a merchandise master database for a category to which it does not belong is prevented. By realizing these means, it is possible to easily associate each page of an electronic catalog with each product of a merchandise master database. Hereunder, an embodiment of the apparatus according to this invention is described referring to FIG. 1 to FIG. 21.

### First Embodiment

<Configuration of a World Wide Web Database System as an Electronic Catalog Management System>

FIG. 1 is a configuration diagram of a system according to this invention. Client PCs 101 and 102 are devices with which a system administrator registers a new data file or performs a system maintenance process such as correcting user administration information, or with which a user enters an instruction such as a merchandise retrieval instruction or a merchandise information output instruction. The devices 101 and 102 are connected to local area networks (LAN) 103 and 109, and they exchange data with other devices through the LANs 103 and 109. A client PC 104 is connected directly to the Internet 105. Although the client PCs 101 and 102 have different connection configurations, they are used for the same purpose. A HTTP server 106 receives a request from a client PC in HTTP protocol through the network. A World. Wide Web (Web) application server 107 processes a request from a client that was received through the HTTP server 106 in accordance with the application. Several Web application servers are registered with the HTTP server 106, and the HTTP server 106 allocates processing to a suitable Web application server in accordance with the contents of the request from the client PC. The Web application server 107 that received a request executes the processing and returns the processing result to the client. A database 108 registers contents data information such as catalog data and image data, text information such as merchandise information, and system information such as user/group information and processing information for registered data files. More specifically, an electronic catalog according to this embodiment is registered in the database 108 and is generated by the Web application server 107. The HTTP server 106, Web application server 107 and database 108 are organically combined in this manner to function as the World Wide Web database system.

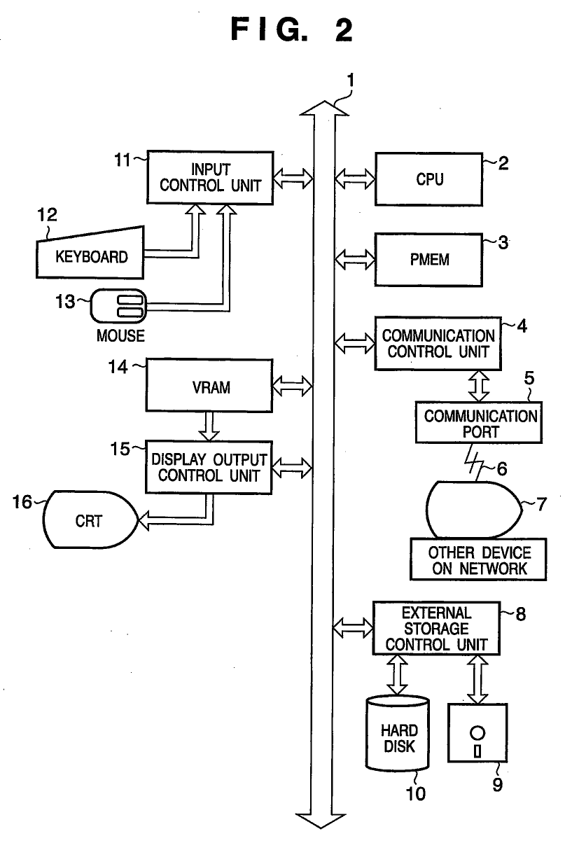

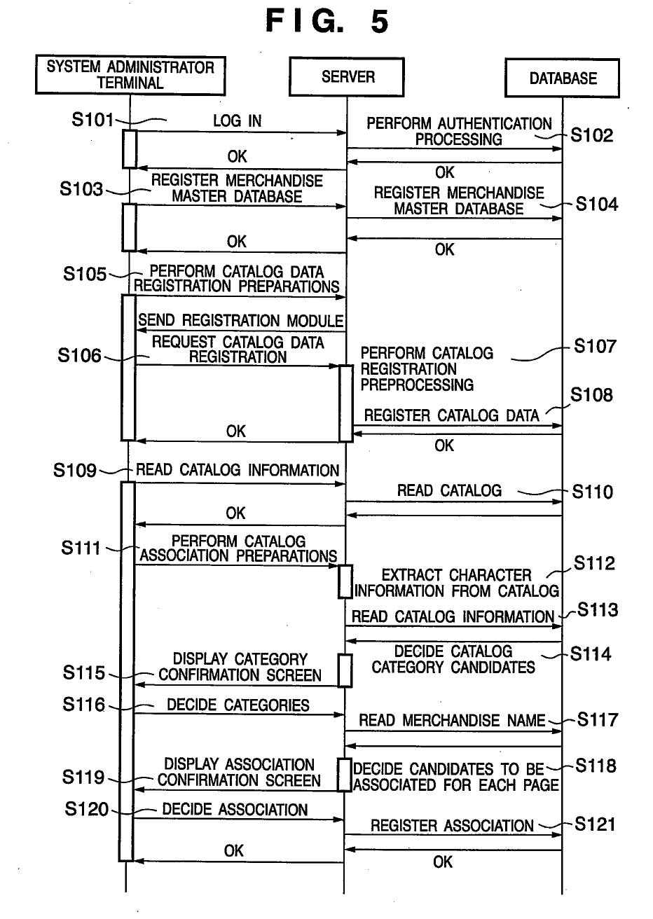

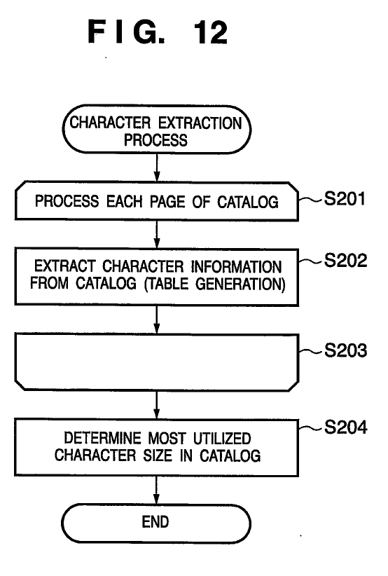

FIG. 2 is a block diagram that describes the configuration of a client PC and each server device of this invention. Since each device is implemented by executing a program that is suited to the respective device by means of a computer, the following description is based on the assumption that the hardware configuration is common among the devices. Each constitutional block of the device is connected to a system bus 1. A CPU (Central Processing Unit) 2 selects and reads suitable programs for processing from a hard disk 10, and loads the programs in a program memory (referred to as PMEM) 3 consisting of a RAM or the like and executes the programs. In addition to an operating system, the programs to be executed include a program for causing a computer to function as the electronic catalog management apparatus of this embodiment, a World Wide Web browser program for implementing, for example, a system administration terminal of FIG. 5, a program for the procedures of FIGS. 12, 13, 15, 16, 21 or the like for implementing a server of FIG. 5, or a database management program for implementing a database or the like. Data entered from a keyboard 12 is stored as code information in the PMEM which also serves as a text memory. A communication control unit 4 controls the input and output of data at a communication port 5. A signal that is output from the communication port 5 is conveyed to a communication port of another device on the network via a communication line 6. Although in this embodiment a description is given regarding a network such as a LAN, naturally this invention can also be applied in a case where a communication port and communication line connected to the communication control unit are constituted by an ordinary public circuit. An external storage control unit 8 controls disks 9 and 10 that are used for data files or program files. For example, the disk 9 is a flexible disk (referred to as “FD”) and the disk 10 is a hard disk (referred to as “HD”). Input devices such as the keyboard 12 and a mouse 13 are connected to an input control unit 11. An operator enters operation instructions and the like for the system by operating the input control unit 11. A pointing device 13 is a pointing device (referred to as “PD”) for designating and manipulating image information on a CRT 16, and in this embodiment a mouse is employed as the pointing device 13. The pointing device moves a cursor on the CRT 16 arbitrarily in the X and Y directions, selects a command icon on a command menu, and enables entry of processing instructions. It can also designate an editing target or a drawing position and the like. Data to be displayed is expanded as bit map data on a video image memory (VRAM) 14, and displayed on the CRT 16 by a display output control unit 15.

In this embodiment a program to be loaded onto the PMEM (RAM) from the hard disk may be stored on another device that is connected to by a network or may also be fixed on a ROM. Further, a program of this embodiment (a program that executes the procedures of FIGS. 12, 13, 15, 16, 21 or the like to be described later) can be supplied to the system or a device through a network or a storage medium such as a FD or HD.

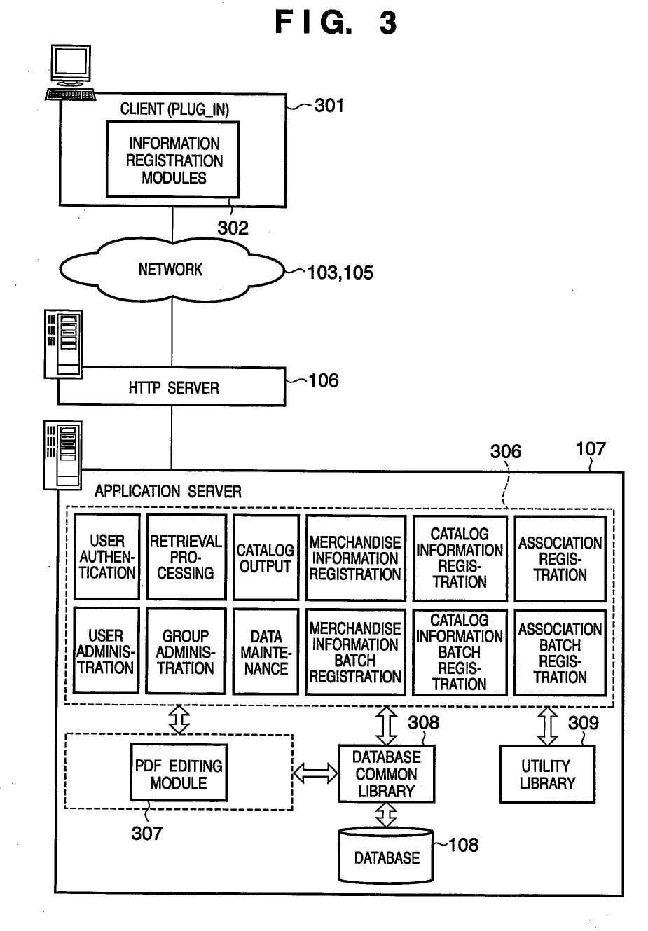

FIG. 3 is a block diagram illustrating a module configuration according to this invention. A client PC 301 stores data files such as catalog information or image data in information registration modules 302 for registration in a server. However, since these modules are delivered automatically as required from a server PC in a plug-in format of a World Wide Web browser application or the like, it is not necessary to perform installation processing on a client PC or the like. Further, since HTML data that describes a page for registration is supplied to the client PC 301 by the HTTP server 106, the information registration module 302 can be replaced with such data. In this example, the client 301 corresponds to clients 101, 102, and 103 shown in FIG. 1.

The Web application server 107 stores modules 306 for processing a request received from the HTTP server 106 originated from the client PC 301. Functions to which the modules 306 correspond include user authentication, retrieval processing, batch registration of various data, merchandise information output and data maintenance functions. These modules are loaded onto a memory in accordance with the request from the client to execute processing.

In addition to these modules, a PDF editing module 307 is provided to perform extraction of text information or image editing of PDF files and the like, as well as editing such as merging or separating PDF files. A library 308 for exchanging data with a database 108 and a library of various utilities 310 are also provided.

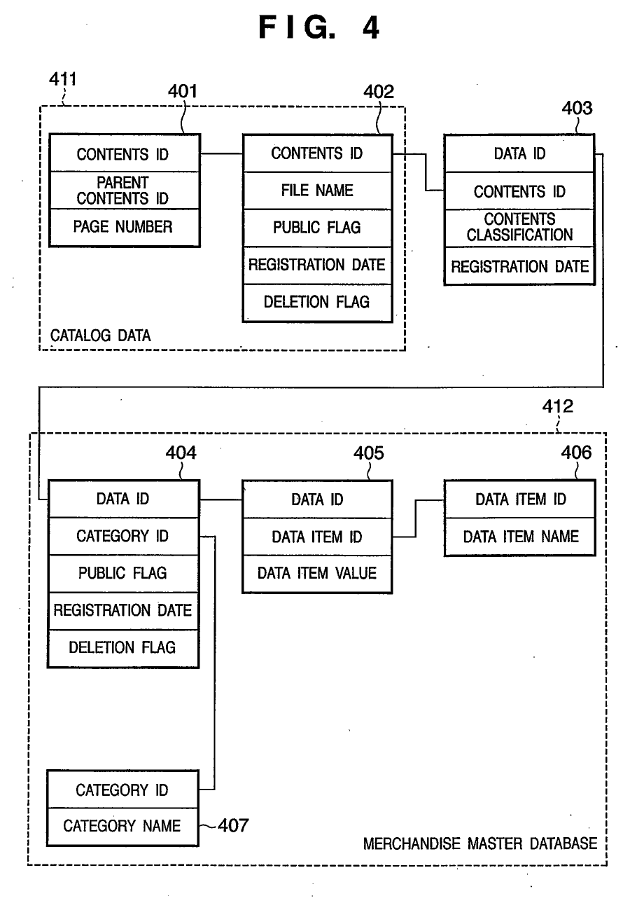

FIG. 4 shows an example of a table of the database 108 in the present system. The contents of the database 108 are broadly classified into catalog data 411, merchandise master data 412 and a data/contents management table 403. Each item of FIG. 4 corresponds to a field belonging to a record in each table. In the merchandise master data 412, a data table 404 manages text information such as merchandise master database information. Examples of information recorded therein include a uniquely determined data ID, a registration date, a renewal date, a public flag that controls whether or not the information is publicly disclosed on the World Wide Web, and a deletion flag that controls whether or not the information is information that was deleted. Further, the data table 404 is associated with a category management table 407 by a category ID to manage which category a data item belongs to. The category management table 407 includes category IDs with corresponding category names. In a data item table 405 are stored a data item ID that is included in a single data item (i.e. data having a single data ID), and the value thereof. For example, the value is stored in association with the item ID for each item such as the merchandise name or price. A data definition table 406 manages (stores) the name of each data item in the data item table 405 that is associated with the data table 404. In the item names are stored item names for merchandise information such as, for example, “merchandise name” or “price”.

A contents table 402 manages information such as catalog data files. Examples of information recorded therein include, similarly to the data table 404, a uniquely determined contents ID, a registration date, a renewal date, a public flag that controls whether or not the information is publicly disclosed on the World Wide Web, a deletion flag that controls whether or not the information is information that was deleted, and a file name that indicates a catalog data file. For contents files of multiple pages, the table is associated with a contents relationship table 401 that manages attribute information for each page (in particular, information showing subordination relationships among the contents). The contents relationship table 401 stores the attribute information of each page of the contents. Examples of the attribute information include a contents ID for each page, page number information, and a parent contents ID showing the contents ID that was stored for the original multiple pages prior to page separation. The parent contents ID shows the subordination relationships among the contents in cases in which, for example, two kinds of merchandise are described in a single catalog and a plurality of pages are separated for each kind of merchandise. A contents ID is assigned to each page as independent contents, and as a parent contents ID that corresponds to that contents ID, a contents ID that was assigned to a grouping of pages for each kind of merchandise is registered. Further, a contents ID that was associated with the contents ID for each kind of merchandise and assigned for the entire catalog is registered as a parent contents ID. In this connection, an intermediate contents ID (for example, in this embodiment, a contents ID for each kind of merchandise) represents an entity that does not itself exist, and functions as a node for summarizing the contents of contents IDs that are subordinate thereto.

The data/contents management table 403 is a table that associates a contents file managed by the contents table 402 of the catalog data 411 with text information managed in the data table 404 of the merchandise master data 412. The data/contents management table 403 can perform association with the data table 404 for each contents ID. Therefore, it is possible to configure each of the contents of the catalog in page units and perform association for the page units. Contents classification data that represents the association classification of contents and the like is also provided. In this embodiment, a unique contents ID is assigned for each page of the electronic catalog as an independent catalog file, and the contents ID is managed by the contents table 402.

<Electronic Catalog Registration Process>

FIG. 5 is a view illustrating one example of a flowchart that shows a process for registration of catalog data according to this invention. First, in step S101, a system administrator (hereunder, also referred to as “user”) performs a login process using a password and account that are entered from a client PC. The authentication method at this time may be a method other than one using an account and password. Upon receiving that request, in step S102 the server performs authentication processing by inquiring to a database to determine whether or not the entered account and password are permitted to execute a process for registration of catalog data. If execution of the process is not permitted, an error screen is sent to the client PC. If execution of the process is permitted, the operation proceeds to the next step.

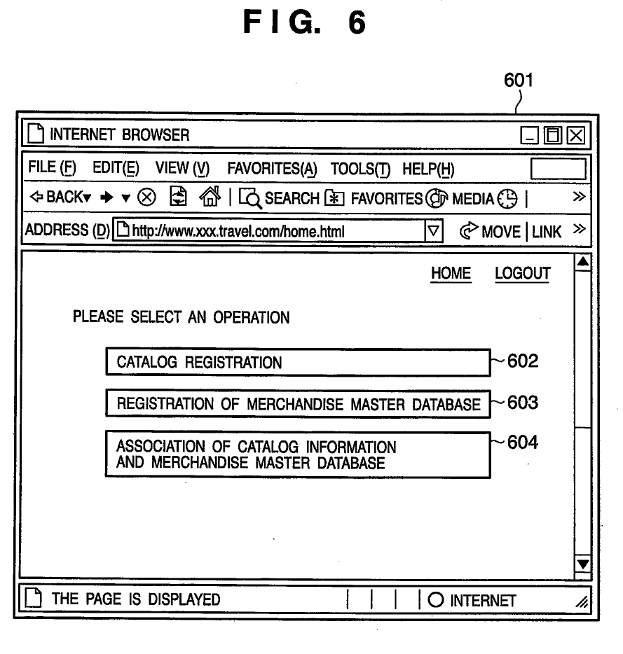

At this time, for example, a screen for registering catalog data for use by a system administrator is displayed. FIG. 6 is a view illustrating an example of a screen listing the catalog registration functions of this invention. By selecting a catalog registration button 602 a user can select catalog data to be registered in the server and execute registration processing. By selecting a merchandise master database registration button 603 a user can register master data of respective merchandise items in the server. Further, by selecting a catalog information and merchandise master database association button 604, a user can associate the merchandise master database 412 and catalog data 411 that were respectively registered in the server.

<Merchandise Master Database Registration>

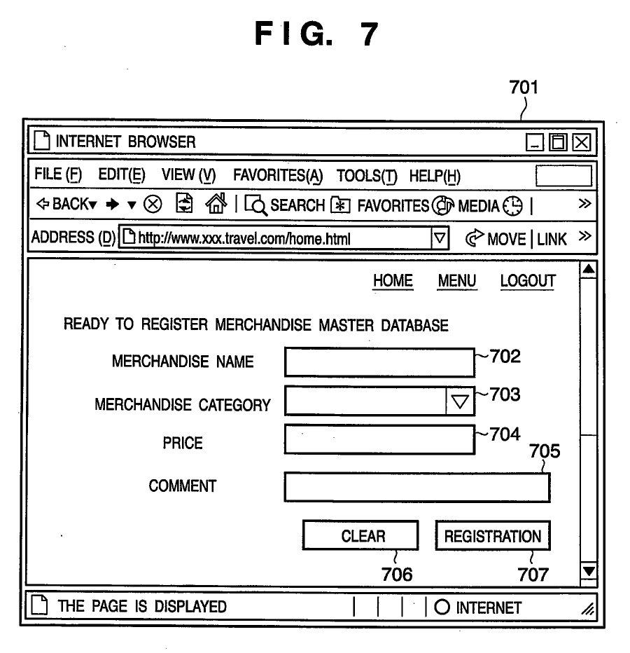

In step S103, registration of a merchandise master database is performed. Upon receiving the request from the client PC, in step S104 the server registers the merchandise master database in the database. FIG. 7 is a view illustrating an example of a screen for registering a merchandise master database of this invention. Reference numeral 701 denotes a screen for setting a merchandise master database. Reference numerals 702 to 705 denote setting items that are registered in the database. The item name of each data item ID included in the data item table 405 is read from an data definition item table 406, to display each item name. In this example, the data item table includes four data items, consisting of merchandise name, merchandise category, price and comment. In the example shown in FIG. 7, an entry field is displayed together with each item name, as illustrated by the display fields 702, 703, 704 and 705 which are provided for the merchandise name, merchandise category, price and comment, respectively. Reference numeral 706 denotes a clear button. When a user selects this button, all the entered information is cleared. Reference numeral 707 denotes a registration button. When a user selects this button, the various information of the merchandise master database that was entered is registered in the merchandise master database. More specifically, steps S101 and S103 may be executed by client modules of the database 108 operating on the client 301, or may be performed by interaction in accordance with HTTP between the HTTP server 106 and the client 301. The screen of FIG. 6 is displayed by either of these methods (or another method).

When catalog registration is selected on the screen shown in FIG. 6, upon receiving that notification the server generates the screen shown in FIG. 7 and sends it to the client 301 for display. Alternatively, an information registration module may autonomously display the screen of FIG. 7. The screen shown in FIG. 7 displays a data item that was registered in the data definition table 406 and a merchandise category, together with the item names thereof, with attached entry fields that allow entry of characters or the like. When the registration button 707 is pressed on the screen of FIG. 7, a record (having the configuration of the merchandise master database 412 shown in FIG. 4) that was allocated with a new data ID is generated and values that were entered for the entry fields 702, 704 and 705, other than the merchandise category, are stored in a data item value field corresponding to the data item ID of the data item table 405. For the merchandise category, categories that were previously determined by the server 107 are displayed to the user as selection options. The user selects one category from the selection options that were displayed. The application server 107 refers to a category conversion table to obtain a category ID based on the selected merchandise category name, and registers that category ID in the category ID column of the data table 404. By this procedure, one record of the merchandise master database 412 of FIG. 4 is completed. By repeating this procedure for the required merchandise items, registration to the database of the merchandise master database is completed. Next, catalog data registration processing is performed.

<Catalog Data Registration>

In step S105, the client 301 starts catalog data registration preparations with respect to the server 107. The server 107 then sends file registration modules to the client PC 301. At that time, the file registration modules are not sent if the modules already exist on the client PC. In step S106, the system administrator selects the catalog data to be registered and sends an instruction to register catalog data to the server. Processing at the client after step S106 is executed by the file registration modules 302.

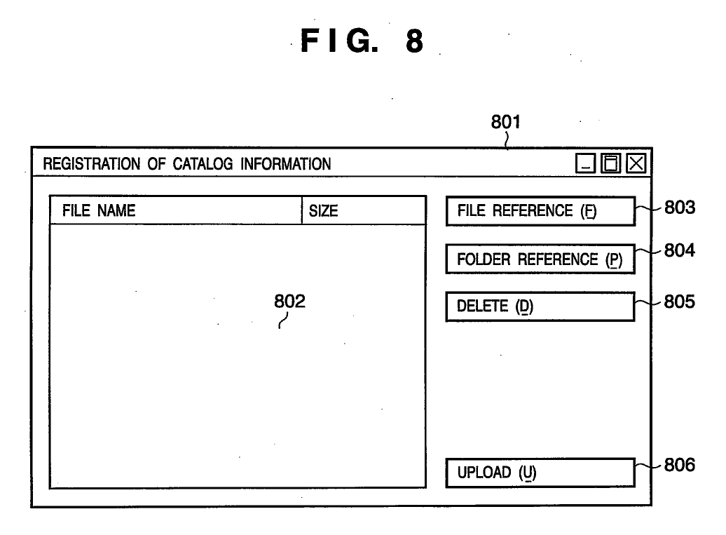

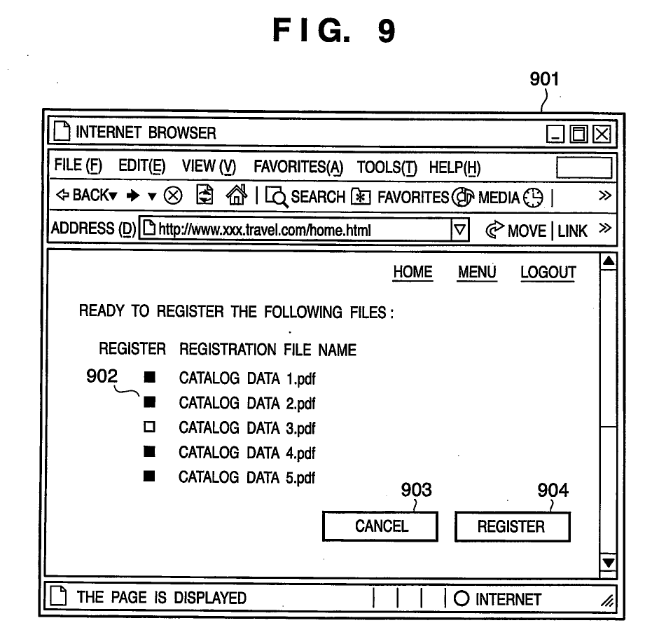

FIG. 8 shows an example of a screen for selecting catalog data to be registered according to this invention. This screen displays file registration modules 302 that were sent from the server 107 to the browser application of the client PC 301. Reference numeral 801 denotes a catalog registration screen. Reference numeral 802 denotes an area that displays a list of files to be registered in the server 107. Reference numeral 803 denotes a button for displaying a file reference screen for selecting files to be registered. When this button is selected a screen for referring to files is displayed, and when files are selected and entered, the selected files are all displayed in the file list 802. Reference numeral 804 denotes a folder reference button. When this button is selected a screen for referring to folders is displayed, and when a folder is selected and entered, all files contained in the selected folder are displayed in the file list 802. Reference numeral 805 denotes a delete button. A user can delete a file from the list of files to be registered by selecting the file to be deleted from the file list 802 and selecting the delete button 805. Reference numeral 806 denotes an upload button. When this button is pressed, processing is performed to register all the files displayed in the file list 802 in the server. When this button is selected, a registration confirmation screen (FIG. 9) is displayed.

FIG. 9 is one example of a screen for confirming data files to be registered in the server. Reference numeral 901 denotes a confirmation screen. Reference numeral 902 denotes a list of files to be registered. Even though a file is displayed in the list, the file can be excluded from the files to be registered in the server by placing a checkbox located at the start of the row of the file in an unselected state. In this example, the file “catalog data 3.pdf” is not registered in the server. Reference numeral 903 denotes a cancel button. When this button is selected, the process of registration to the server is cancelled. Reference numeral 904 denotes a registration button. When this button is selected, files that are selected are registered in the server. In this example, catalog files to be uploaded to the server are in PDF (Portable Document Format) format. Further, even when a file to be uploaded is composed by a plurality of pages, the file is a single PDF file that is integrated as a catalog.

In step S107, the server that received the registration request performs preprocessing for catalog registration. In this case, the server separates the catalog data file that was designated for registration (in this example, a PDF file) into page units and generates a file for each page. As the file name of the page units at this time, the server attaches a 5-digit page number to the original file name. However, a rule for naming a file is not limited thereto. The server also generates thumbnail images respectively for the catalog data and the generated files. In step S109, the server sends the result of preprocessing to the database to perform registration processing for the catalog data. At this time, for example, for a file that was separated into pages, all of the files for the separated individual pages are registered in the database together with the original file. The corresponding thumbnail image files are also registered in the database. When preparations for registration with the database were completed normally the server sends a screen indicating normal completion to the client PC. The registration of catalog data in the database is then completed by processing. The processing will now be described in accordance with FIG. 4. A contents ID is allocated respectively to an uploaded catalog file and page files that were generated by separating the catalog file into separate pages. The contents ID and the file name (including the file location) corresponding thereto are registered in the contents table 402. Further, since the relationship between the catalog file prior to separation and a catalog file of a page unit after separation is that the latter belongs to the former, the contents ID of the page unit and the contents ID of the catalog file prior to separation that corresponds thereto as well as the page number that the page unit catalog file occupied in the original catalog file are registered in the contents relationship table. Thumbnails are, for example, stored together with the files for each page. In this manner, the catalog data 411 shown in FIG. 4 is configured by preprocessing.

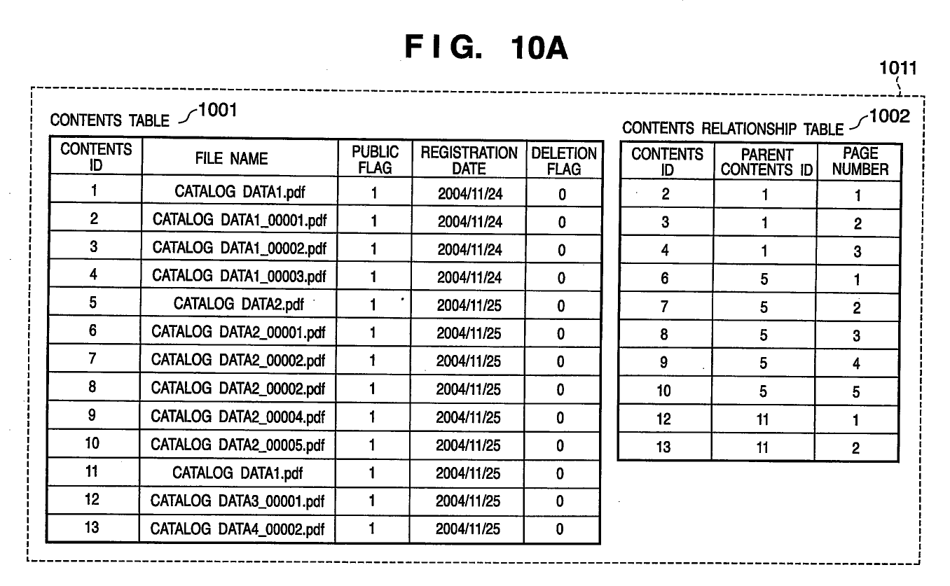

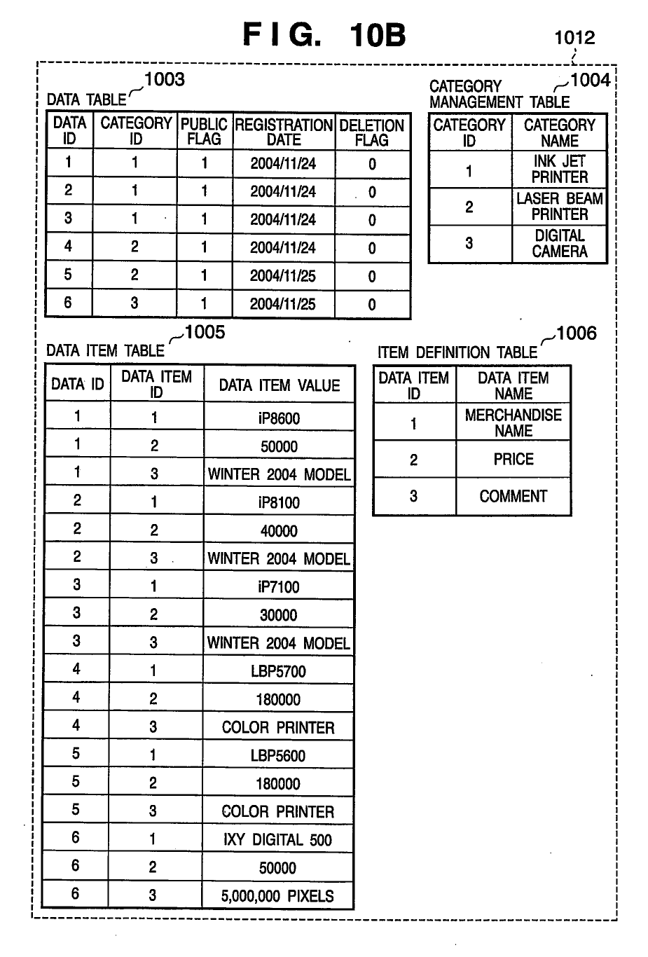

FIGS. 10A and 10B are views illustrating an example of the contents of the database when merchandise master database registration and catalog registration were completed. Reference numeral 1001 denotes an example of the contents table 402 that manages registered catalogs. Registered catalogs and separated catalogs are assigned with sequential contents IDs, respectively, for management. Reference numeral 1002 denotes an example of the contents relationship table 401 that manages parent-child relationships with respect to the catalogs. Each page of a catalog that was separated into pages is associated with the contents ID of the original catalog that was separated into pages as a parent contents ID, and also has information indicating which page of the original catalog the data is for. In the example shown in FIGS. 10A and 10B, the three contents represented by the contents IDs 1, 5 and 11 are uploaded catalog files. The catalog files represented by the contents IDs 2-4 are files that were generated by separating the catalog file represented by contents ID 1 into page units. The catalog files represented by the contents IDs 6-10 are files that were generated by separating the catalog file represented by contents ID 5 into page units. The catalog files represented by the contents IDs 12-13 are files that were generated by separating the catalog file represented by contents ID 11 into page units. The respective pages are registered in the contents relationship table 1002 such that the catalog file prior to separation is taken as the parent contents.

Reference numeral 1003 denotes an example of the data table 404 that manages information of the merchandise master database. Each merchandise master data (record) is assigned with a sequential data ID for management. The record of each merchandise item is also associated with the ID of the category to which it belongs. Reference numeral 1004 denotes an example of the category management table 407 that manages categories. Each merchandise category is assigned with a sequential ID for management. Reference numeral 1005 denotes an example of the data item table 405 that manages the actual values of merchandise master database information, and in which values of data Items are stored. The values are associated with the data table by the corresponding data ID, and also associated with the data definition table by the data item ID. Reference numeral 1006 denotes the contents of a data definition table that manages the names of data items. The data item names are assigned sequential IDs for management.

<Association Processing>

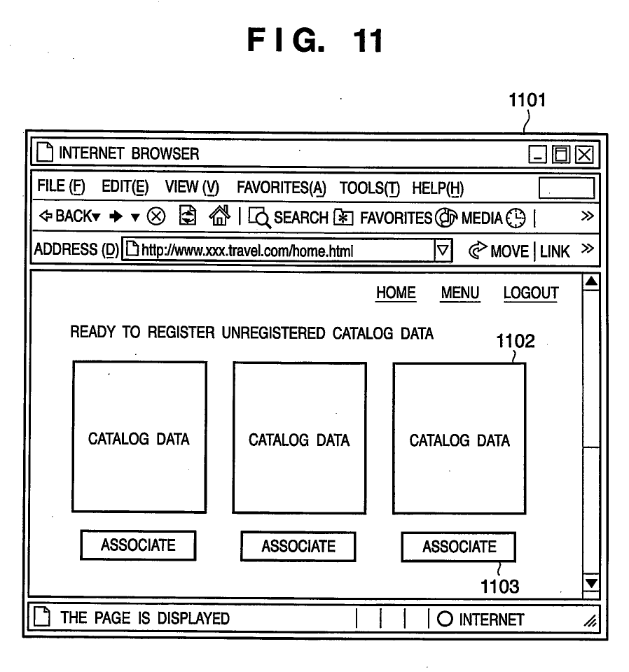

Next, processing is performed to associate the merchandise master database and the catalog data. First, in step S109, the client 301 reads the catalog data that underwent registration processing. Upon receiving that request, in step S110 the server 107 reads catalog data that has not been associated with the registered merchandise master database from the database and sends the data to the client PC. The client PC then selects the catalog data to be associated. FIG. 11 is an example of a screen for confirming and selecting catalog data that has not been associated with the merchandise master database that exists in the server. Reference numeral 1101 denotes a confirmation screen. Reference numeral 1102 denotes a listing of catalog data that has not been associated. The catalog data is displayed in list form. Reference numeral 1103 denotes an associate button. When a user selects this button, association processing for the selected catalog data begins. In this example, since there is only one merchandise master database as an association partner, the user does not specify the association partner. However, if there is a plurality of merchandise master databases with which the catalog data has not been associated, the user would also select the desired association partner by the procedure of FIG. 11.

Upon receiving the association request, in step S112, as preprocessing for the catalog association, the server first extracts character information including the content (character code), size and position of characters from all pages in the selected catalog. FIG. 12 is a flowchart showing the details of the character extraction preprocessing of step S112. Steps S201 and S203 indicate that the processing performed between these steps is processing that is repeated for each page of the catalog. In step S202, the character information inside the catalog is acquired. After character information was acquired for all pages, in step S204 information regarding the character size that is most frequently utilized in the entire catalog is determined from all the character information included in the catalog. Although it is assumed that the catalog file of this embodiment is a file that includes character codes therein, in a case where the catalog file does not include character codes, character information can be generated by performing character recognition processing. Further, the acquired character information is stored in association with each page of the catalog as a character information file or the like for each page.

In step S113, the server acquires category information from the database. In step S114, the server that received the association request performs category decision processing for the catalog as preprocessing of the catalog association. The server can acquire the categories by reading all the entries of the category management table.

FIG. 13 is a flowchart showing the details of the category decision processing. In step S301, the server performs a search to determine whether or not characters that match a category name registered in the category management table are present in character information included on the first page of the catalog. More specifically, the server searches for a category name registered in the category management table 407 based on the character information file that was associated with the first page of the catalog and stored. In step S302, the server determines whether the category characters exist as the result of the search process of step S301. When the category characters exist, in step S303, the server selects the category of the category name that exists among the contents of the first page. For example, the server stores the position of the character string of the category name. In step S304, in addition to the contents of the first page, for characters at positions that were stored in step S303, unless there is a category name for which confirmation screen generation processing is to be performed to display the fact that the characters are a category name in a distinguishable condition, for example, by inverting the colors or the like, the confirmation screen generation processing of step S304 is performed without making any particular selection. Further, on this screen, a list of category names as selection options, i.e. a list of the category names acquired in step S113, is displayed together with checkboxes for enabling selection. In the initial state, category names included in that page are in a selected state. In step S115, the confirmation screen information that was generated in step S114 is passed to the client PC and displayed. In this connection, although in step S301 categories were retrieved on the basis of the character information of the first page, depending on the type of catalog, in some cases there may be a high probability that information relating to the categories is contained on the last page. In that case, categories may be retrieved on the basis of character information included on the last page. Depending on the type of catalog, a configuration may also be adopted whereby the user sets the page to be searched. Further, although the process proceeds to step S304 to display a user confirmation screen when no category characters exist at step S302, a configuration may also be adopted whereby when no category characters exist at step S302 category characters are retrieved on the basis of character information other than the information of the first page. Then, if category characters exist the process proceeds to step S303, and if category characters do not exist the process proceeds to step S304.

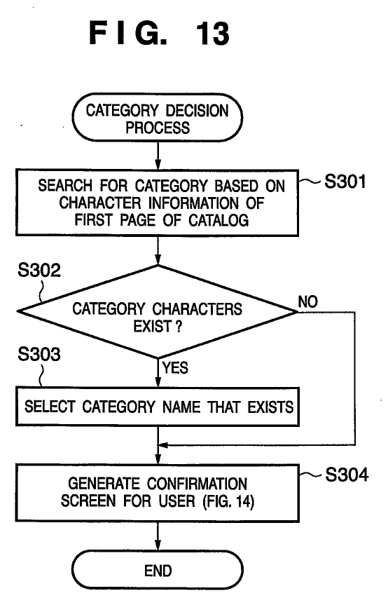

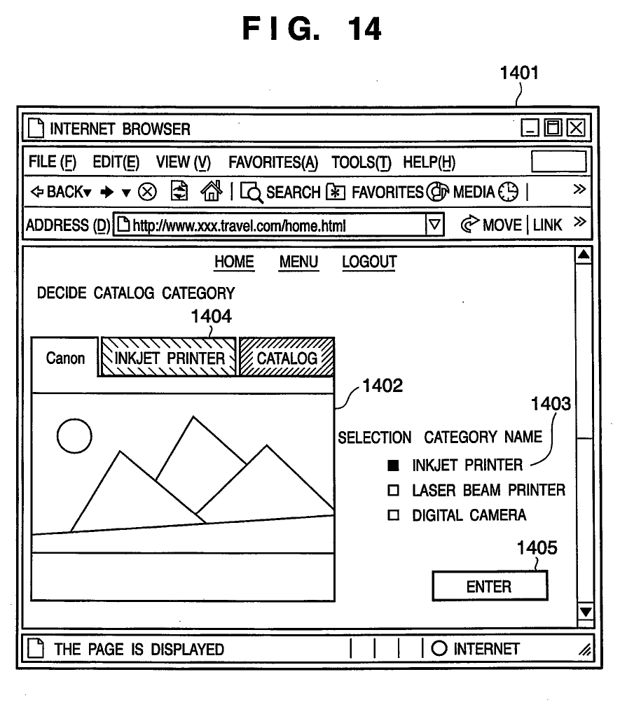

FIG. 14 illustrates an example of a screen for confirming the categories of a catalog. Reference numeral 1401 denotes a confirmation screen. Reference numeral 1402 denotes an area of the screen showing the first page of the catalog to be associated. Reference numeral 1404 denotes character information that matches a category extracted from the first page. Reference numeral 1403 denotes a list of categories present in the system and the selection details thereof. In this example, since the category characters for inkjet printer 1404 exist in the catalog, a selected state is shown in accordance with step S303. When a catalog category is incorrect, the information can be amended to reflect the correct information by changing the selected/unselected state of the checkbox. Reference numeral 1405 denotes an Enter button. When this button is selected, the selected category information is notified to the server.

In step S116 the category that the user decided is notified to the server. In step S117, the server reads the merchandise names in the decided category. When the merchandise master database is constructed using a commonly used database system, an access to the merchandise master database can be made, for example, by issuing a query describing conditions from the client to the server to read data that conforms to the conditions. The processing of step S117 and the like is executed using that kind of database application. Although in this example merchandise names are read in step S117 in order to associate merchandise names and each page of the catalog, other information such as a price or the like registered in the merchandise master database may be used.

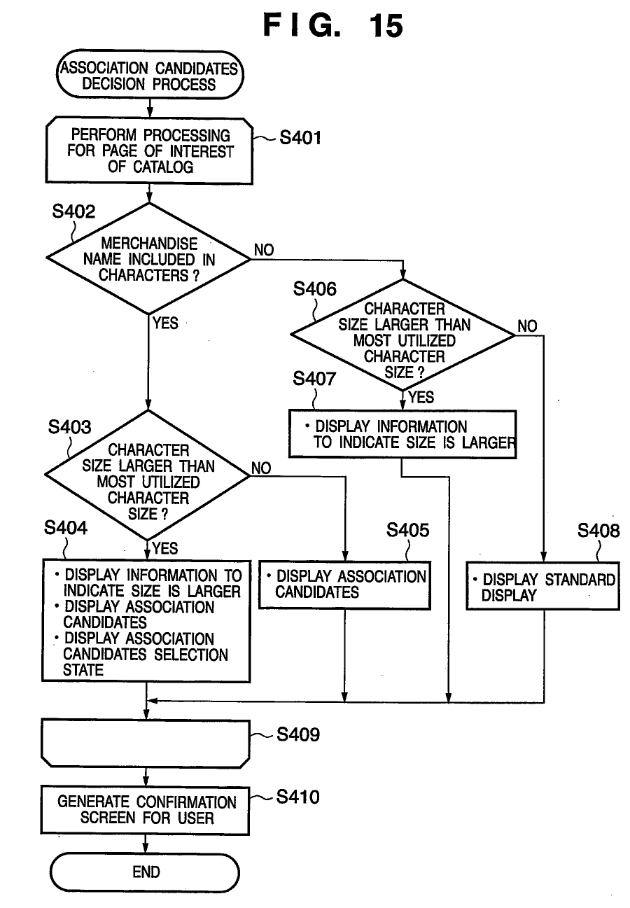

In step S118, the server decides candidates to be associated with the merchandise master database for each page of the catalog. FIG. 15 illustrates a flowchart showing the details of the association decision processing. Steps S401 and S409 indicate that the processing of steps S402-S408 is performed for each page of the catalog. In this connection, when processing is being performed for one page, that page which is the object of processing is referred to as “page of interest”. In step S402, based on the character information contained in the page of interest of the catalog, the server checks among the records in the data table of the merchandise master database to see whether a record is associated with an item for which a category was notified in step S116, and whether characters exist in the item of that record which match characters of a data item value corresponding to a merchandise name (i.e. value of the merchandise name field). For a character string that matches a merchandise name (relevant character string), in step S403 the server checks whether the size of the character (the average size in the case of a plurality of characters) is larger than the character size acquired in step S204. If the size is larger, in step S404 the server associates display state information consisting of display state information to indicate that the character size of the relevant character(s) is larger, display state information for displaying the relevant character string as a candidate to be associated, and display state information for displaying the selection state of the candidate to be associated, respectively, with the relevant character string of the page of interest, and stores the information. If the size is not larger, in step S405 the server associates the display state information for displaying the relevant character string as a candidate to be associated, with the relevant character string of the page of interest and stores the information. When the characters do not match in step S402, in step S406 the server checks whether there is a character for which the character size is larger than the character size acquired in step S204. If there is a character of a larger size, the server associates display state information for a display to indicate that the relevant character string is larger with the character string in question and stores the information in step S407. If there is no character of a larger size, the server stores information indicating to that effect in order to display the characters normally. In step S408, no information to be stored is required. In step S410, processing to generate a confirmation screen for the user is carried out based on the above processing. In this connection, in steps S404, S405, S407 and S408, candidate information for displaying the relevant characters as candidates to be associated or as candidates that were initially selected is associated and stored for each page of the catalog data, and generation of the actual screen information is performed in step S410.

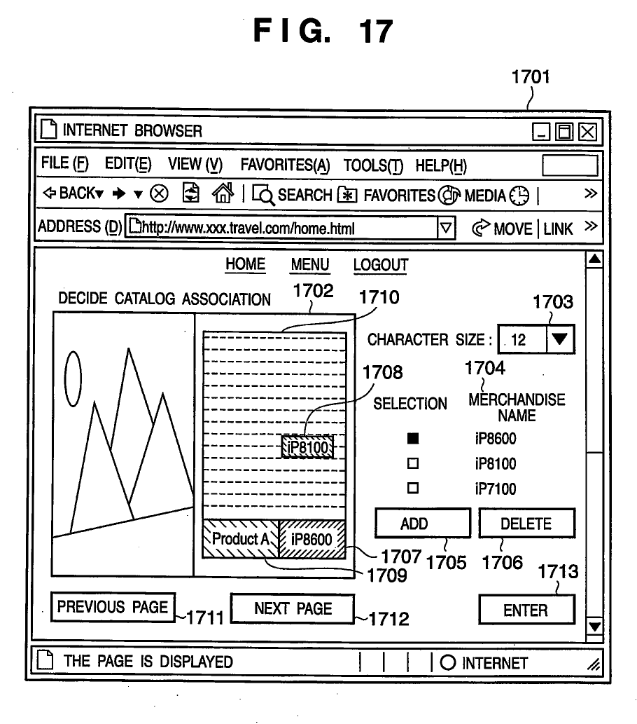

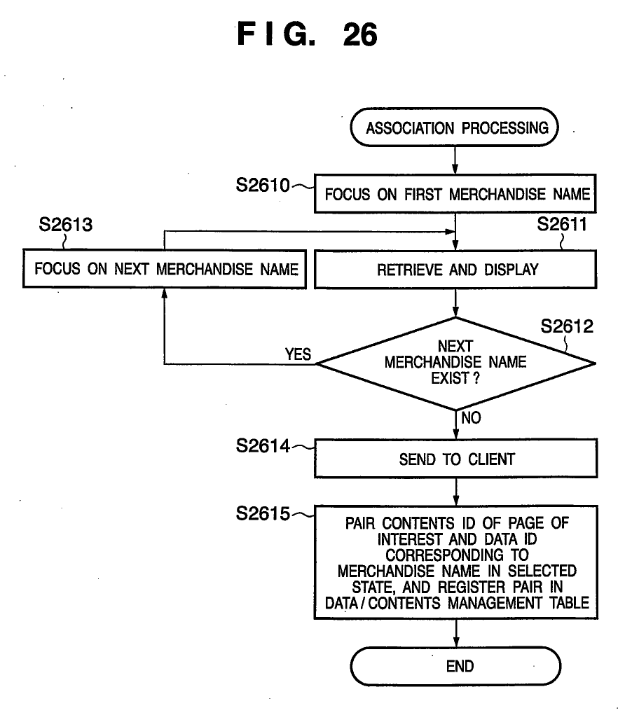

FIG. 26 is a flowchart that summarizes the association processing. This processing is performed for each page of the catalog. In step S2610, the server focuses on one among all the merchandise names belonging to a category selected from the merchandise master database, and in step S2611 the server retrieves that merchandise name from the page of interest and stores the obtained retrieval result. This retrieval operation is repeated for all merchandise names of the selected category (S2612, S2613). The obtained merchandise names are sent as candidates to be associated to the client PC together with the PDF file of the page of interest (S2614). An association screen as shown in FIG. 17 is displayed at the client. The server 107 refers to a response corresponding thereto, and pairs the contents ID of the page of interest with the data ID corresponding to a selected merchandise name, and registers the pair in the data/contents management table 403 (S2615).

<Generation Process of a List of Candidates to be Associated>

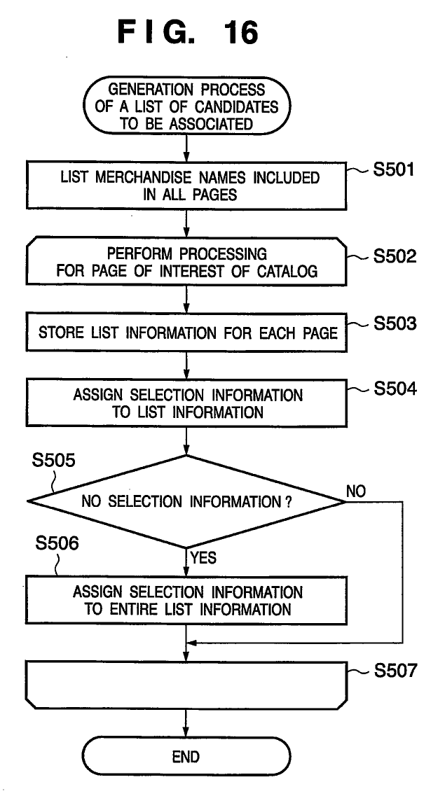

FIG. 16 is a flowchart showing the details of a generation process of a list of candidates to be associated that is performed as one part of screen information generation for generation of a confirmation screen (S410 of FIG. 15). In step S501, the server generates list information that lists all the merchandise names acquired by the processing of step S402. Steps S502 and S507 indicate that the processing from step S503 to step S506 is repeated for each page of the catalog. In this connection, a program may be configured to repeat the processing for each page until step S410 of FIG. 15. In that case, since the entire processing of FIG. 16 is repeated in step S410, steps S502 and S507 are not required.

In step S503, processing is performed that stores the list information generated in step S501. Naturally, step S503 can be omitted if the generated list information is stored as it is in a referable condition in step S501. In step S504, processing is performed that reflects the selection results of merchandise names (display state information for displaying the corresponding merchandise name of the candidate information in a selected state) that were acquired in step S404 in the list information. All merchandise names acquired in step S404 that are included in the page of interest are assigned a selected state. The selected state is, for example, represented by a checkbox. In step S505, the server checks whether or not there is a merchandise name that was assigned a selected state in step S504. When there is no merchandise name in a selected state, the entire list of candidates of information (merchandise names) as association objects is taken to be in a selected state for the page of interest. For example, checkboxes attached to the merchandise names are all checked. As a result, all the merchandise master database included in the catalog becomes a candidate-to be associated. Thus, merchandise name candidates to be associated with each page of the catalog are generated.

In step S119, the confirmation screen generated in step S118 is sent from the server to the client and displayed. FIG. 17 is an example of a screen for confirming an association. Reference numeral 1701 denotes a confirmation screen. Reference numeral 1702 denotes data for one page of a catalog undergoing association. By selecting a previous page button 1711 or a next page button 1712, it is possible to switch the catalog page to display a different page. That is, the page of interest can be changed. Reference numeral 1703 denotes the character size that was acquired in step S204. When the user wants to change the character size, a list of all character sizes used In the catalog is contained in a drop-down list to enable the user to change the character size. If the user changes the character size, the processing of FIG. 15 and FIG. 16 is executed again. Reference numeral 1704 denotes a list of candidates to be associated that was acquired by the processing illustrated in FIG. 16. It is possible to change the merchandise name to be associated by changing the checkmark at the start of the name. An add button 1705 makes it possible to add merchandise master database information that does not exist in the list of candidates. By adding information, a merchandise item is newly added to the list. A delete button 1706 makes it possible to delete a merchandise name from the list of candidates. When an addition or deletion process is performed, the processing illustrated in FIG. 16 is executed again. An Enter button 1713 is used to execute a decision of the merchandise master database to be associated. Reference numeral 1707 denotes the state decided in step S404. Reference numeral 1708 denotes the state decided in step S405. Reference numeral 1709 denotes the state decided in step S407. Reference numeral 1710 denotes the state decided in step S408. When the Enter button is pressed, the page of interest of the catalog data is associated with records of the merchandise master database corresponding to the merchandise name(s) selected (checked) at that time. For example, the contents ID of the page of interest and the data ID corresponding to the checked merchandise name are temporarily stored as an associated table at the client.

In step S120, the associated information that was decided and stored by the client in step S119 is notified to the server 107, and in step S121 the information is registered in the data/contents management table 403 of the database 108. Registration is performed in accordance with the associated information that was stored at step S119 of FIG. 5. More specifically, for example, in a case where a given contents ID and data ID are associated, the data ID and contents ID are registered in accordance with that association in the data/contents management table 403.

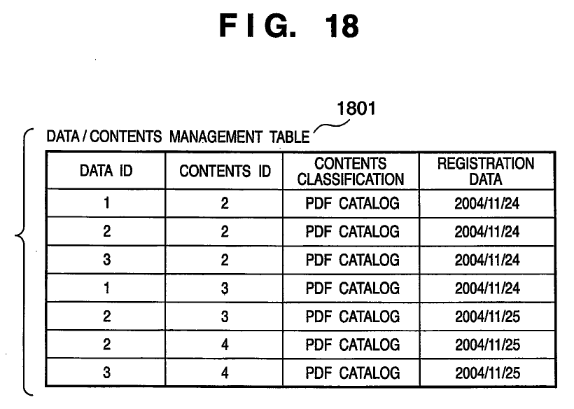

FIG. 18 is a view Illustrating an example of the contents of the data/contents management table 403 in a case where association of catalog data and a merchandise master database was performed for the database shown in FIGS. 10A and 10B. In this example, the catalog page data (files of page units after catalog separation) for which the contents ID is 2 and the merchandise master databases with the data IDs 1, 2 and 3 are associated, the catalog page data for which the contents ID is 3 and the merchandise master databases with the data IDs 1 and 2 are associated, and the catalog page data for which the contents ID is 4 and the merchandise master databases with the data IDs 2 and 3 are associated. The contents classification for all of the contents classification is “PDF catalog.” This classification can be decided, for example, at the server 107 based on the file names or file extensions of the catalog files that were uploaded from the client.

According to the above described procedures, catalog data and a merchandise master database are uploaded to the server or registered, the server collates data of character strings and the like appearing in the catalog with data of character strings and the like appearing in the merchandise master database, and presents matching character strings to the user as candidates for character strings to be associated together. Thus, it is no longer necessary for the user to search the merchandise master database for each page and perform all the association by manual operations. Further, by having the computer retrieve the data of character strings or the like, association can be performed exactly without any omissions.

<Catalog Output Process>

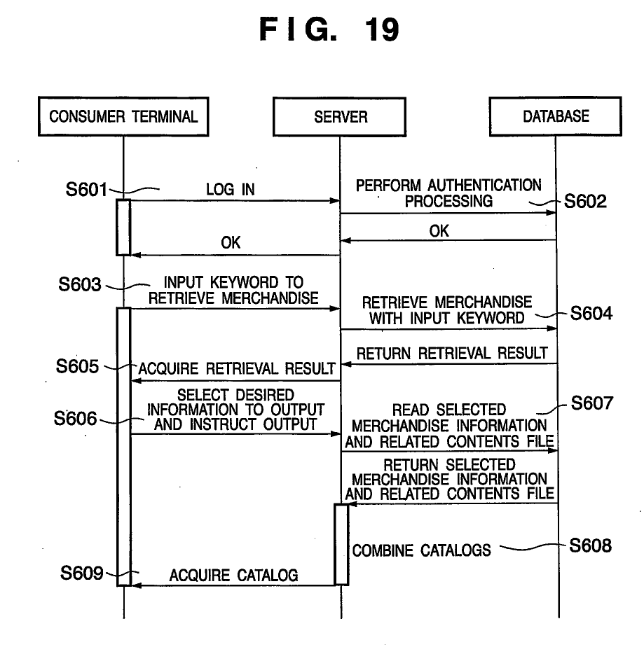

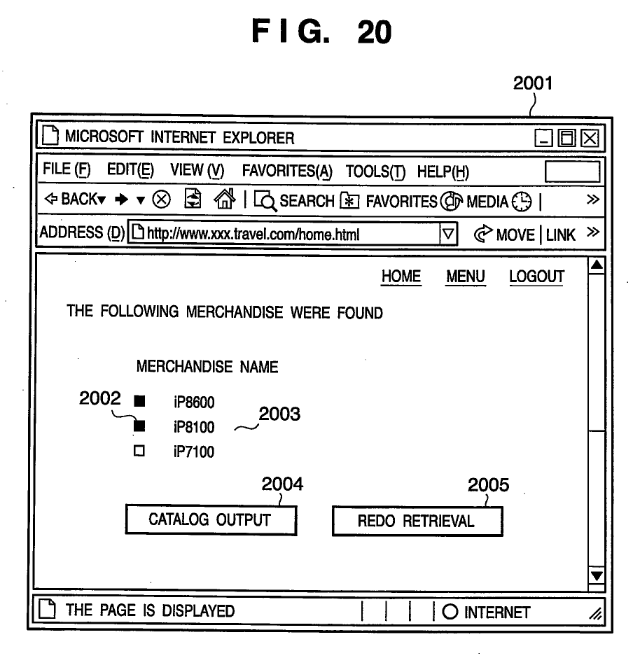

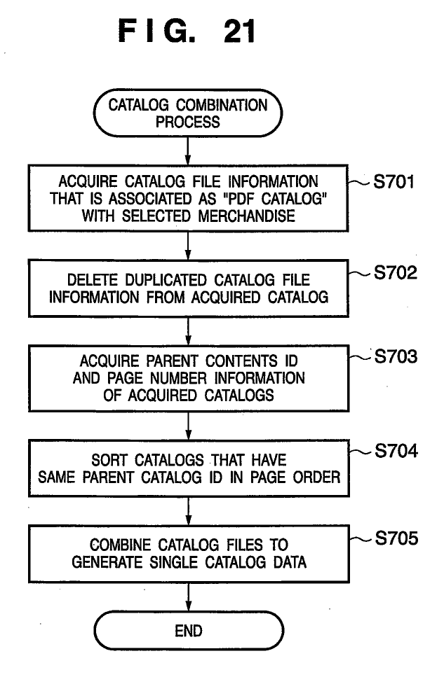

FIG. 19 shows an example of a flowchart illustrating a catalog data output process according to this invention. First, in step S601, a reader (also referred to as “consumer”) of the electronic catalog performs login processing with an account and a password from a client PC. At this time, the authentication method may be a method other than an account and password. Upon receiving this request, in step S602 the server 107 performs authentication processing by inquiring to a database to determine whether or not the entered account and password are permitted to use the system. If use of the system is not permitted, an error screen is sent to the client PC. If use of the system is permitted, the operation proceeds to the next step. In step S603 the reader enters a keyword from the client to retrieve merchandise data. Upon receiving the retrieval request from the client, in step S604 the server retrieves merchandise information corresponding to the entered keyword at the database, and sends the result to the client PC as a merchandise data list. The retrieval operation in step S604 is performed with respect to the merchandise master database 412. In step S605, the client PC acquires the merchandise retrieval result. FIG. 20 illustrates an example of a merchandise retrieval result screen to be displayed at the client PC. Reference numeral 2001 denotes a merchandise retrieval result screen. A list 2003 shows merchandise information (in this example, merchandise names) that was acquired by the retrieval operation. The reader selects the merchandise whose catalog they want to output by checking a checkbox 2002, and when the reader selects catalog output using a button 2004 the catalog of the selected merchandise is downloaded. The processing in the server at this time will be described referring to FIG. 21. Further, reference numeral 2005 denotes a redo retrieval button. When this button is selected, the display returns to the retrieval screen to allow the reader to redo the retrieval.

Next, an output instruction is sent for the merchandise information selected in step S606. Upon receiving the request, in step S607 the server reads the specified merchandise information from the database. The information to be read out at this time includes contents files that have a contents ID that was associated with the data ID of the selected merchandise. More specifically, the server retrieves a data ID having the selected merchandise name as a data item value, and refers to the data/contents management table 403 using the obtained data ID to read out all the corresponding contents IDs. The contents table of the catalog data is searched using these contents IDs to read the corresponding file names. The obtained file names represent catalog page files corresponding to the merchandise selected by the reader, and therefore the file names are stored. Based on the acquired information, in step S608 the server 107 performs processing to generate a catalog by combining the catalog page files having the file names that were stored in step S607. In step S609, the server sends the thus-combined catalog to the client PC. Thus, the reader can acquire the selected merchandise catalog.

FIG. 21 is a flowchart detailing the process for combining catalogs. This process corresponds to steps S607 and S608 of FIG. 19. First, information of catalog files that are associated under the contents classification “PDF catalog” with the merchandise selected in step S701 is acquired. More specifically, contents IDs that are associated with the data ID of the selected merchandise and for which the contents classification is “PDF catalog” are retrieved from the data/contents relationship table 403. Next, file names corresponding to the obtained contents IDs are retrieved from the contents table 402. The catalog file information is then stored, for example, as a list of the obtained file names. In step S702, duplicate information is deleted from the acquired list of catalog file information so that identical pages are not included in the final output result. For example, if duplicate file names exist, one of the files is retained and the other file(s) is deleted from the list. In step S703, the server refers to the contents relationship table 401 to acquire the parent contents ID of contents IDs relating to the acquired catalog file information and the relevant page number information, and stores this information. In step S704, based on the acquired information, the server sorts file names corresponding to contents IDs that have a common parent catalog ID in page number sequence. In step S705, the server reads the catalog files in the sorted order, and combines the files to generate data for a single catalog. More specifically, when a catalog is requested for a merchandise item that was associated with any page of the original catalog (catalog prior to page separation), the entire original catalog is provided to the reader as one whole item.

According to the above described procedures, when retrieving merchandise data (in this example a merchandise name) from a merchandise master database, catalog data that was associated in page units with the obtained merchandise can be acquired, edited and provided to the user (reader). Further, when constructing the catalog database, by selecting candidates to associate merchandise names described in the catalog with the merchandise master database based on common data (for example, merchandise names) and providing them to the user (catalog provider), association of the merchandise master database and the catalog can be performed quickly and easily. In addition, the merchandise master database can be searched using a desired keyword, without performing a catalog search for the entire document, and the related catalog contents can be retrieved using a data/contents relationship table based on the obtained data, and this also allows the retrieval to be performed quickly. More specifically, it is possible to automatically associate a category with each page of a catalog. Furthermore, by associating each page of the catalog with categories on the first page, the number of cases of association with unrelated categories decreases, and thus association can be performed automatically and accurately.

### MODIFIED EXAMPLE

Although the present embodiment described a case in which merchandise master data and catalog data are registered for each merchandise item, in a case where merchandise master data or catalog data is already constructed in a configuration as shown in FIG. 4 (excluding the data/contents management table 403), they may be registered in one batch with the application server 107. In that case, after registering the respective data in the application server 107, if the process of FIG. 5 is executed from step S109 it is possible to generate the data/contents management table 403 and complete the electronic catalog.

In this example, association of catalog pages and a merchandise master database is performed using merchandise names. However, other methods that can be considered include, for example, retrieving a character string that matches a part of a character string included in a comment item of the merchandise master database from the catalog and presenting it to the user as a candidate to be associated. By adopting this configuration, association of a merchandise master database and a catalog can be performed more flexibly.

Further, when a reader is retrieving a catalog, although in this example retrieval is performed with a merchandise name, once a data/contents relationship table has been generated any item may be employed as a key as long as it is included as an item of the merchandise master database and a data ID can be obtained by the retrieval operation. For example, the merchandise master database may be searched using a category, and the corresponding contents can be acquired from the obtained data ID. It is also possible to search the merchandise master database employing price as a key, and acquire the corresponding contents from the obtained data ID. Naturally, since a database is being searched, logical addition or logical multiplication or the like can be added to the search conditions to obtain a catalog matching the conditions.

### Second Embodiment

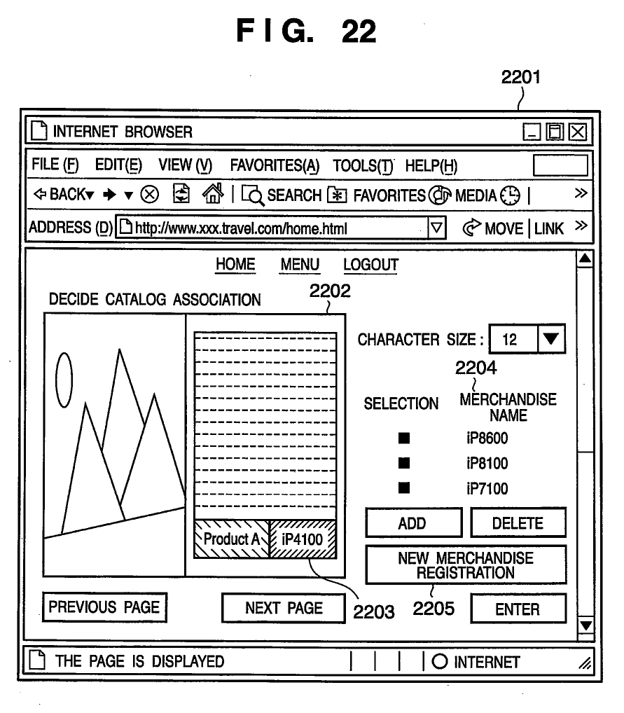

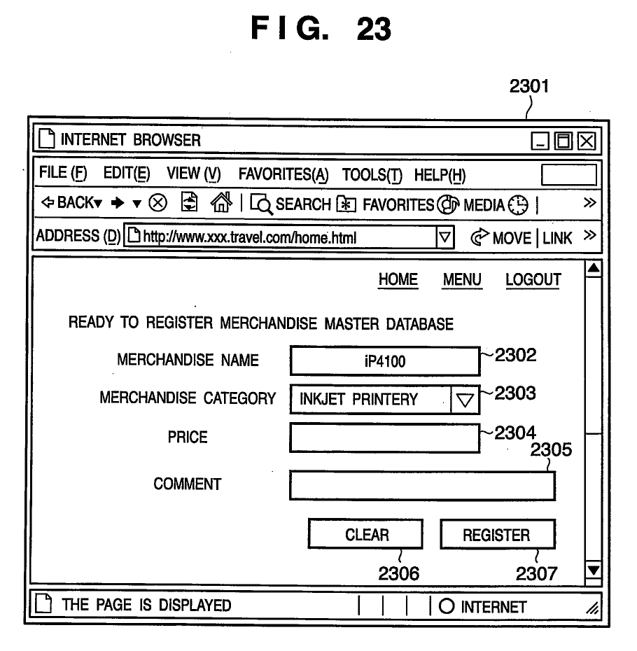

A second embodiment of the apparatus according to this invention will be described referring to FIG. 22 and FIG. 23. This embodiment is an apparatus in which the features of the apparatus of the first embodiment were expanded. In this embodiment, when a merchandise master database for association does not exist at the time of catalog registration, association is performed while newly registering merchandise master database information.

FIG. 22 illustrates an example of a screen for deciding association for a catalog. FIG. 22 corresponds to the processing of FIG. 17 of the first embodiment, and the fundamental operations thereof are the same as in FIG. 17. Reference numeral 2201 denotes a confirmation screen. Reference numeral 2202 denotes data for one page of a catalog to be associated. Since merchandise names are not included in this catalog, candidates to be associated 2204 are all in a selected state. In this embodiment, registration of a new merchandise item is possible by selecting a button 2205. At this time, by pressing the registration button while the test “iP 4100” of a page of interest catalog screen 2203 is in a selected state, the selected character string (iP 4100) can be registered as a new merchandise item in the merchandise master database. When new merchandise is registered, that merchandise is also added to the list of candidates to be associated 2204 and the processing of FIG. 15 and FIG. 16 of the first embodiment is carried out.

FIG. 23 illustrates an example of a merchandise registration screen that is displayed when the button 2205 was selected. Reference numeral 2301 denotes a screen for setting a merchandise master database. Reference numerals 2302 to 2305 denote setting items that are registered in the database. On this screen, reference numeral 2302 denotes a merchandise name, and the text selected at 2203 is input here by default. Reference numeral 2303 denotes a merchandise category, and the catalog category information that was defined in the processing of the preceding screen is input here by default. Reference numeral 2304 denotes a merchandise price, and reference numeral 2305 denotes other comment information. Reference numeral 2306 denotes a clear button. When this button is selected, all the information that was input is cleared. Reference numeral 2307 denotes a registration button. When this button is selected, the input merchandise master database information is registered in the database. The above processing completes the registration to the database of a merchandise master database. The registration itself is performed in the same manner as in the first embodiment.

By configuring the apparatus in this way, merchandise that is not registered in a merchandise master database can be registered while associating catalog data with the merchandise master database.

### Third Embodiment

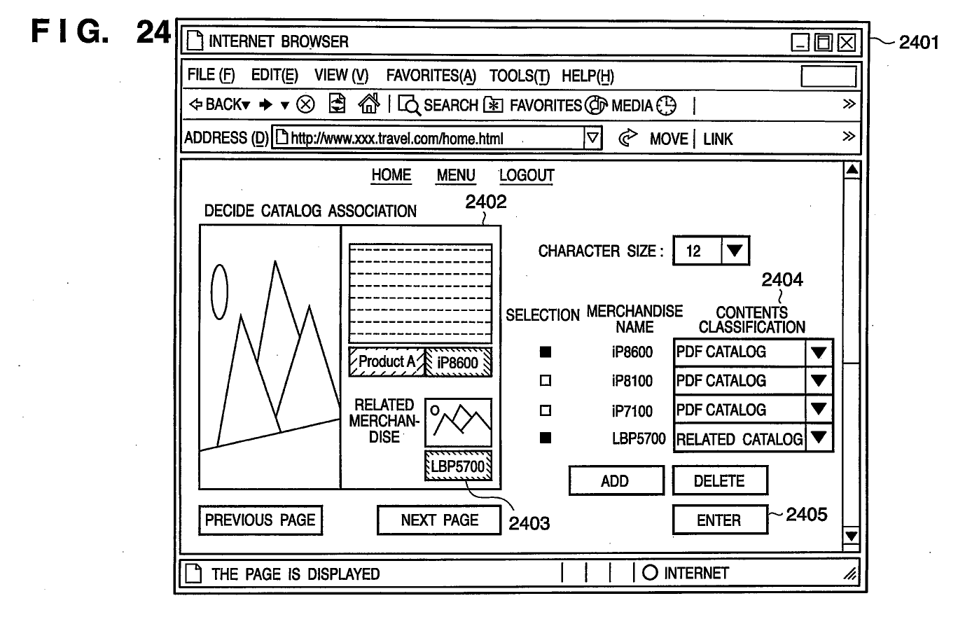

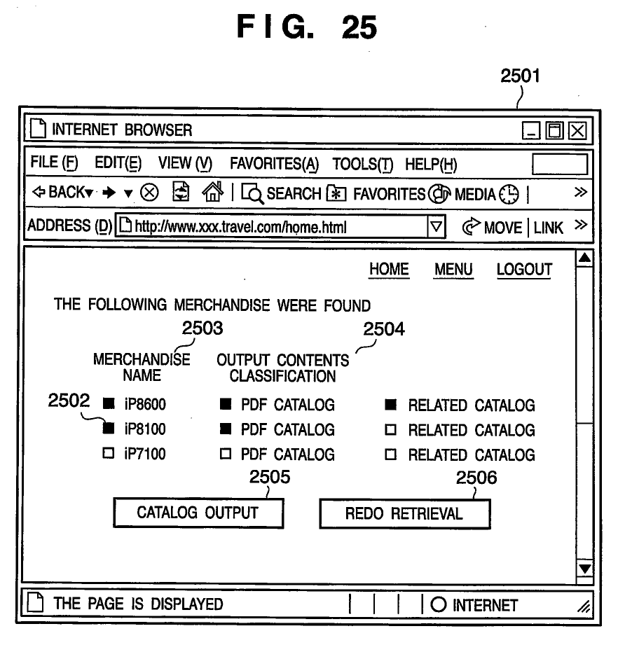

Hereunder, a third embodiment of the apparatus according to this invention will be described referring to FIG. 24 and FIG. 25. This embodiment is an apparatus in which the features of the apparatus of the first embodiment were expanded. In this embodiment, when associating a catalog and a merchandise master database, as the contents classification of the data/contents management table 403 information is registered that indicates whether or not a merchandise item belongs to a category decided in step S116 of FIG. 5. More specifically, the contents classification is separated into a plurality of types based on category information that was decided by processing to associate a catalog and a merchandise master database and, when outputting a catalog, the catalog to be output is modified in accordance with a value of the contents classification corresponding to the catalog ID.

FIG. 24 illustrates one example of a screen for deciding association of a catalog. The processing of FIG. 24 corresponds to the processing of FIG. 17 of the first embodiment. The fundamental operations of the association processing are the same as those described for FIG. 17. In FIG. 24, reference numeral 2401 denotes a confirmation screen. Reference numeral 2402 denotes data for one page of a catalog to be associated. This catalog includes a merchandise name “iP 8600” as merchandise that belongs to a selected category and a merchandise item “LBP 5700” denoted by reference numeral 2403 that does not belong to a selected category of this catalog. Therefore, in candidates to be associated 2404, since a character string “iP 8600” matches the merchandise name of a selected category that was registered in the merchandise master database, it is stored on the list as an associated candidate and a selected candidate, and it is displayed as a candidate in a selected state on the display.

According to this embodiment, a merchandise name belonging to a category other than a selected category can also be retrieved from the catalog of interest. Therefore, for example, when performing association processing after previously registering category IDs that are related to each other in the server 107, in addition to the selected category, the merchandise name of merchandise having the category ID of a category that was associated with the selected category is also retrieved from the page of interest. Then, for example, a flag such as a category flag is temporarily generated for each merchandise item that was found, and a given value is set for merchandise that corresponds to the selected category and another value is set for merchandise that corresponds to a category that was not selected. On the display of the client PC, as shown in FIG. 24, “PDF catalogs is displayed for the merchandise of a selected category and “related catalog” is displayed for merchandise that does not belong to a selected category. When the selection result is sent from the client 301 to the server 107, the server 107 associates the contents ID of the page of interest with the data ID of the selected merchandise in accordance with the selection, and registers the information in the data/contents management table 403. Further, in accordance with the category flag of the selected merchandise, as described above, “PDF catalog” or “related catalog” is registered in the contents classification column. It is also possible to previously register data IDs that relate to each other. In this case, if a data ID is registered as a data ID that relates to a data ID obtained from a merchandise master database using a keyword, the merchandise name of that data ID is retrieved from the page of interest of the catalog. Association is then performed and related catalog“is registered for the catalog ID of that merchandise.

Thus, the differences to the first embodiment are that a contents classification that shows the association classification exists at 2204 and that a merchandise item called “LBP 5700” that is merchandise not included in a catalog category is in a selected state. According to this association, when merchandise is included in a catalog category it can be registered in the PDF contents classification as a PDF catalog, and when the merchandise is not included in a catalog category it can be registered as a related catalog. In this connection, the contents classification can be selected and changed by the user. When the user selects a button denoted by reference numeral 2405, association is performed.

FIG. 25 illustrates an example of a merchandise retrieval result screen of this invention. It corresponds to the processing of FIG. 20 of the first embodiment, and the basic operations thereof are the same as FIG. 20. Reference numeral 2501 denotes a merchandise retrieval result screen. Reference numeral 2503 denotes simple information concerning merchandise. Reference numeral 2502 denotes selection of a merchandise item the user wants to output. The difference with the first embodiment is that the contents classification the user wants to output can be selected, as denoted by reference numeral 2504. When catalog output as denoted by reference numeral 2505 is selected, the catalog of the selected merchandise is downloaded. At that time, when only PDF catalog was selected as the contents classification, only a catalog that is associated as a PDF catalog is taken as the output object, and when related catalog was selected, only a catalog that is associated as a related catalog is taken as the output object. When both of these are selected, catalogs that were associated under both classifications are taken as the output object. Reference numeral 2506 denotes a redo retrieval button. When this button is selected, the display returns to the retrieval screen to allow the reader to redo the retrieval operation.

In order to output a catalog in this manner, having received a response (i.e. information showing the selection state) to the screen shown in FIG. 25, the server retrieves a data ID corresponding to a specified merchandise name from the merchandise master database, and searches the data/contents management table 403 using the obtained data ID. At that time, an additional retrieval condition in the response information from the client is that the retrieval result corresponds with the selected contents classification. A contents ID that matches the conditions is the contents ID of the required catalog. Means for reconstituting and outputting the catalog based on the contents ID is the same as in the first embodiment.

By carrying out processing in this manner, according to this embodiment even if merchandise is not included in the category of merchandise that was retrieved using a keyword, it is possible to output the catalog of that merchandise. Further, for example, by previously performing association between a category and merchandise, when associating a merchandise master database and a catalog, the merchandise names and the like of the category for which the association was previously registered can also be selected as candidates to be associated. It is therefore possible to perform association processing quickly and to broaden the range of association.

By implementing the electronic catalog server of the present embodiment in this manner, support that takes into consideration catalog categorization and character size can be provided for the association process to assist a user in associating a merchandise master database and a catalog when the user carries out catalog registration. As a result, the user can perform catalog registration and association more easily than in the conventional method.

### Other Embodiments

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Examples of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website,via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

This application claims the benefit of Japanese Patent Application No. 2005-025504 filed on Feb. 1, 2005, which is hereby incorporated by reference herein in its entirely.

What is claimed is:

1. A catalog management apparatus that is capable of managing a database in which merchandise related information that relates to merchandise is registered in a retrievable condition as a record, and catalog data which contains information relating to merchandise comprising:
a retrieval unit that retrieves catalog data one by one in predetermined constitutional units using predetermined merchandise related information; and
an association unit that, when the merchandise related information is found in the catalog data by the retrieval unit, generates an association table in which the constitutional units are associated with a record of the database that includes the merchandise related information.

2. The catalog management apparatus according to claim 1, in which a category name corresponding to merchandise is included in the record of the database and the constitutional units are page units, further comprising:
a category retrieval unit that, before the merchandise related information is retrieved by the retrieval unit, retrieves a first page of the catalog data with a category name that is registered in the database;
wherein the retrieval unit retrieves constitutional units of interest of the catalog data by means of merchandise related information that is associated with a category name obtained by the category retrieval unit.

3. The catalog management apparatus according to claim 2, wherein the association unit includes a candidate output unit that outputs merchandise related information that is found in the catalog data as candidates for merchandise related information corresponding to a record to be associated with the constitutional unit, and when a user makes a selection from among the candidates, the association unit generates an association table that associates a record including the selected merchandise related information with the constitutional unit.

4. The catalog management apparatus according to claim 3, wherein when the retrieval unit does not find merchandise related information in a constitutional unit of interest of the catalog data, the candidate output unit outputs all merchandise related information included in the entire catalog data as candidates for merchandise related information corresponding to a record to be associated with the constitutional unit.

5. The catalog management apparatus according to claim 1, further comprising:
a second retrieval unit that searches the database with a keyword;
a catalog identification unit that, when a record relating to the keyword is identified by the second retrieval unit, refers to the association table to identify a constitutional unit of catalog data corresponding to the record; and
an output unit that outputs as a catalog retrieval result a constitutional unit of catalog data that is identified by the catalog identification unit.

6. A catalog generation method that is capable of managing a database in which merchandise related information that relates to merchandise is registered in a retrievable condition as a record, and catalog data which contains information relating to merchandise, comprising:
a retrieval step that retrieves catalog data one by one in predetermined constitutional units using predetermined merchandise related information; and
an association step that, when the merchandise related information is found in the catalog data by the retrieval step, generates an association table in which the constitutional unit in question is associated with a record of the database that includes the merchandise related information.

7. A catalog retrieval method for retrieving catalog data that is generated by the catalog generation method according to claim 6, comprising:
a second retrieval step that searches the database with a keyword;
a catalog identification step that, when a record relating to the keyword is identified by the second retrieval step, refers to the association table to identify a constitutional unit of catalog data corresponding to the record; and
an output step that outputs as a catalog retrieval result a constitutional unit of catalog data that is identified by the catalog identification step.

8. A computer program recorded on a computer-readable storage medium, which can implement the catalog management apparatus according to claim 1 by execution of the program by a computer.

9. An electronic catalog recorded on a storage medium that is accessible by a computer, including:
a catalog contents table including a contents ID and a file name corresponding thereto;
a merchandise master database table in which are associated a data ID, a category to which the data belongs, and a data item included in the data; and
a data/contents management table in which a data ID and a contents ID are associated;
wherein the electronic catalog is constituted such that, when a value of the data item is assigned, a computer can perform an operation to acquire a data ID by searching the merchandise master database table, search the data/contents management table using the acquired data ID to acquire a contents ID that is associated therewith, and identify a corresponding file name using the acquired contents ID.

10. A catalog registration apparatus, comprising:
a selection unit that, when registering catalog data, selects a category to be registered based on characters of a specific page of catalog data; and
a unit that associates catalog data with a category that is selected by the selection unit.

11. A catalog registration apparatus, comprising:
a display unit that, when registering catalog data, displays candidate categories to be registered based on characters of catalog data; and
a unit that associates catalog data with a category that is selected from the categories displayed by the display unit.

12. A catalog registration method, comprising:
a selection step that, when registering catalog data, selects a category to be registered based on characters of a specific page of catalog data; and
a step of associating catalog data with a category that is selected by the selection step.

13. A catalog registration method, comprising:
a display step that, when registering catalog data, displays candidate categories to be registered based on characters of catalog data; and
a step of associating catalog data with a category that is selected from the categories displayed by the display step.

14. A computer-readable program that is a program recorded on a computer-readable storage medium, wherein the program causes a computer to implement:
a selection step that, when registering catalog data, selects a category to be registered based on characters of a specific page of catalog data; and
a step of associating catalog data with a category that is selected by the selection step.

15. A computer-readable program that is a program recorded on a computer-readable storage medium, wherein the program causes a computer to implement:
a display step that, when registering catalog data, displays candidate categories to be registered based on characters of catalog data; and
a step of associating catalog data with a category that is selected from the categories displayed by the display step.
